(19) United States
(12) Patent Application Publication
(10) Pub. No.: US 2003/0136910 A1
(43) Pub. Date: Jul. 24, 2003

(54) Dual function sensor system

(75) Inventor: Christopher Frederick Carter, Northampton (GB)

Correspondence Address: WILLIAM B. PATTERSON, MOSER, PATTERSON & SHERIDAN, L.L.P., Suite 1500, 3040 Post Oak Blvd., Houston, TX, 77056, US

(73) Assignee: Infrared Integrated Systems Ltd.

(21) Appl. No.: 10/341,965

(22) Filed: Jan. 14, 2003

(30) Foreign Application Priority Data
Jan. 15, 2002 (GB) 0200826.6

(51) Int. Cl. G01J 5/02

(52) U.S. Cl. 250/339.02

(57) ABSTRACT

Radiation falling on a two dimensional detector array is analysed with respect to two perpendicular directions whereby two different characteristics can be analysed with one array. Possible characteristics include the variation intensity with wavelength, spatial position or path length through a sample.

### BACKGROUND OF THE INVENTION

1. Field of the Invention

Two dimensional arrays of electromagnetic radiation sensors are widely used in imaging and spectroscopic systems. One such array is shown in EP-A-0853237. Typically such arrays have a number of individual detector elements arranged in rows and columns. Most commonly, focal plane arrays are used in conjunction with a suitable lens to image a scene; the outputs from the pixels of the array may then be processed into a picture for human inspection or processed for computer algorithms to analyse. The wavelength at which such a scene is viewed may be determined by a filter covering the whole array or by a jigsaw arrangement of many filters covering different parts of the array. Alternative techniques include the use of one or more prisms, diffraction gratings or graded filters to spread spectral information over both axes of the array.

### SUMMARY OF THE INVENTION

The present invention is an instrument using such a two dimensional sensor array but in which detector elements along the two perpendicular directions of the array gather information of different types. For example, one axis could gather spatial information and the second axis spectroscopic information. In preferred embodiments, extensive use is made of known graded filters which are band pass interference filters in which the centre wavelength of the band pass varies along one direction but is constant in an approximately perpendicular direction; such a band pass filter may sometimes be advantageously constructed as two superimposed edge filters—one of the ‘cut on’ type and the other of the ‘cut off’ type.

The advantages of such a system are many: there is a cost saving since two functions are combined in one instrument; there is also the advantage that the two measured parameters are linked in an important way and it is thus critical to measure them at the same time.

This invention is defined in annexed claim 1. Preferred features are detailed in claims 2 to 12. The invention also provides a method as claimed in claim 13 with preferred features detailed in claims 14 to 24.

In some embodiments a sample of a material to be analysed is placed between the array and a radiation source. The sample may cause the radiation to have certain spatial characteristics due to the thickness, temperature or chemical composition of the sample.

### BRIEF DESCRIPTION OF THE DRAWINGS

Three example embodiments of the invention will now be described by way of example only and with reference to the accompanying drawings in which:

FIGS. 1A and 1B are a schematic side elevation and top plan respectively of apparatus for carrying out a first method according to the invention;

FIGS. 2A and 2B are schematic side elevation of apparatus for carrying out a second method according to the invention, FIG. 2A viewing the detector array from a direction perpendicular to the viewing direction of FIG. 2B; and

FIGS. 3A and 3B are schematic side elevations of apparatus for carrying out a third method according to the invention, FIG. 3A viewing the detector array from a direction perpendicular to the viewing direction of FIG. 3B.

### DETAILED DESCRIPTION OF THE PREFERRED EMBODIMENT

1. Apparatus to characterise a flame like object.

The equipment uses a cylindrical lens and a linear graded filter so that the spatial extent of the object (e.g. height) is imaged in one direction of the array and the spectroscopic output of the object is measured in the other direction. By this means it is possible to distinguish a flame from flame-like objects and also estimate the distance of the flame by virtue of the absorption edge shifting with the depth of atmosphere.

The cylindrical lens is a known optical component whose surface has the shape of a section of a cylinder; in contrast the better known spherical lens is a section of a sphere. A cylindrical lens focuses radiation in one direction only hence transforming a point in the target plane into a line in the image plane. In this example the lens would be formed from an infra-red transmitting material such as germanium and would be coated to improve the transmission.

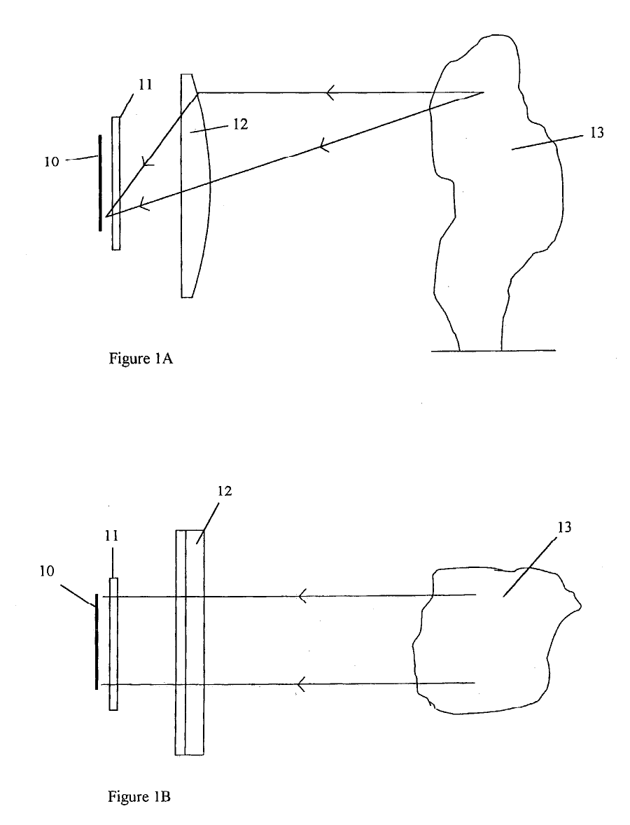

FIGS. 1A and 1B show a practical arrangement for this apparatus. A planar two dimensional array 10 of infrared sensitive detector elements is mounted close to a graded filter 11; the array is at the focus of a cylindrical lens 12 which is shown viewing a distant flame 13. If we take the array physical size as about 10 mm×10 mm, the lens focal length as 8 mm and the filter as a band pass filter graded from a pass band centred on 4.3 micrometres to a pass band centred on 4.7 micrometres at a bandwidth of 0.05 micrometres, then it will be possible to estimate the spectral emission of the target (i.e. the flame) over the region in which flames are known to emit infra-red energy and also over which the atmosphere absorbs, and simultaneously map the vertical extent of the target over a 10 m height at an 8 m range.

In the vertical plane, FIG. 1A, the curved face of the lens 12 projects the vertical aspect of the flame 13 onto the array 10; in this plane any thin single vertical cross section of the graded filter 11 transmits at the same wavelength.

In the horizontal plane, FIG. 1B, the cylindrical lens 12 does not focus and radiant energy from the flame is directly incident on the array; in this plane the graded filter 11 is functional and the energy incident on the array will be filtered according to the filter specification—in the example shown this will vary from 4.3 μm to 4.7 μm.

In summary, the array 10 sees a spatial image of the flame in the vertical plane but a spectral image in the horizontal plane. Horizontal spatial information is lost.

The data from such an instrument can be analysed by known means, most commonly to provide positive confirmation that the target is indeed a flame; this will be evident from the spectral distribution of energy between 4.3 μm and 4.7 μm. The distance, size and intensity of the flame can also be estimated because atmospheric absorption will have the effect of narrowing the aforementioned band; the vertical size of the flame is directly presented on the vertical axis of the array and the intensity can be derived by integrating the intensity of each illuminated pixel of the array.

2. Apparatus to measure high concentrations of a strongly absorbing substance such as carbon dioxide.

This equipment uses a wedge shaped absorption cell placed immediately in front of the array in conjunction with a linear graded band pass filter that corresponds to the absorption band of the substance in question e.g. 4.0 to 5.0 μm for carbon dioxide. The apparatus is illuminated with wide band radiation e.g. from an incandescent lamp and is arranged so that the signal along on one axis of the array varies with path length and along the other axis of the array varies with wavelength. The band width of this band pass filter would typically be about 0.05 micrometres.

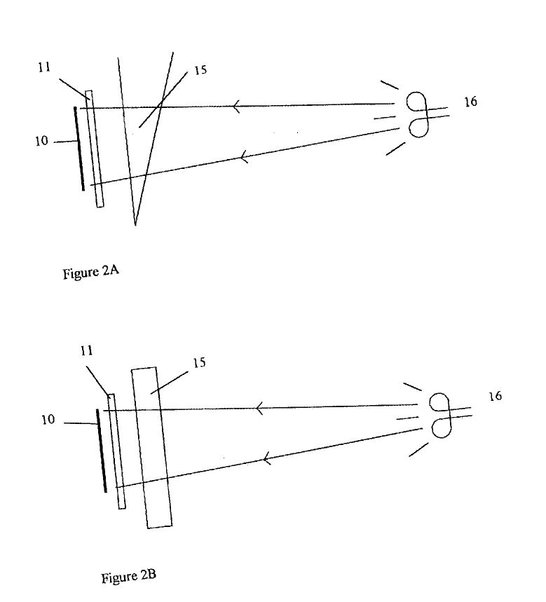

FIG. 2A and 2B show a schematic practical arrangement for this apparatus. A focal plane array 10 is mounted close to a graded filter 11 and directly behind the wedge shaped sample cell 15. The graded direction of the filter 11 is along the line of constant path length through the sample cell 15, as shown in FIG. 2B. The plane of the filter 11 that is ungraded (i.e. at constant wavelength) is along the line of tapered path length through the cell 15, as shown in FIG. 2A. The available path length for such an instrument could vary from 0.1 mm at one end to about 2 mm at the other.

In practice, radiation from a point source 16 is used to illuminate the array 10 having passed through the tapered sample cell 15. If the sample cell contains an infrared absorbing material (such as carbon dioxide in this example), certain wavelengths will be blocked and this will apparent from the signals on the array 10. In the vertical plane the signals will vary because of a changing path length, whilst in the horizontal plane the signals will vary because of a changing wavelength. The absorption characteristics of the gas will hence be known simultaneously over a wide range of both wavelength and path length; known means can then be used to calculate the concentration of gas in the sample cell with high accuracy.

3. Apparatus to improve the accuracy of an infrared absorption measurement.

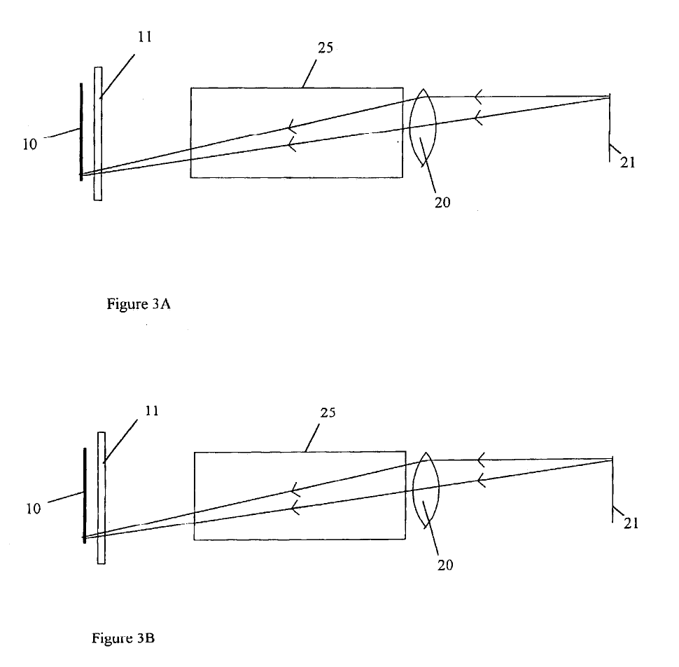

This equipment is shown schematically in FIG. 3A and 3B and is an enhancement to known non-dispersive infrared analysers. A lens 20 is used to project the image of a hot source 21 onto a focal plane array 10; the radiation passes through a sample cell 25, which may change the spectral characteristics of the radiation and hence provide means to measure the concentration and identity of the substances in cell 25. The spectroscopic analysis is provided by a graded filter 11 which in this case will indicate the radiation intensity between 4 μm and 5 μm as shown in FIG. 3B. The perpendicular plane of the array shown in FIG. 3A is ungraded and the image intensity will correspond to the source intensity at constant wavelength. Other wavelength ranges can be chosen of course to match the application.

The infrared sources are frequently non-uniform and can show time varying fluctuations in output; one advantage of the arrangement shown in FIG. 3 is that the array sees a spatial image of the source in one direction and a spectral image of the source in a perpendicular direction. A combination of the two data sets will lead to improved accuracy.

The apparatus of FIG. 3 could also be of value in the absence of a sample cell 25 if the source 21 had an emissivity that changed with wavelength, perhaps indicating a varying chemical composition. The apparatus would be able to map these changes and perhaps use the information in a process control application. It will be appreciated that the separation of spectral and spatial information in such apparatus would be less clear than in the example of FIG. 1 but nevertheless the spatial information has been found to be surprisingly useful.

1. A method of analysing radiation falling on a planar two-dimensional array of radiation detector elements by examining first and second different characteristics of the radiation with respect to the first and second directions which are perpendicular to each other and parallel to the plane of the array, in which filter means are placed between the radiation source and the array, the filter means being designed to cause a variation in the intensity of the radiation falling on the array with respect to its wavelength along one of said first and second directions.

2. A method as claimed in claim 1 in which the filter means comprise a cut-on or cut-off filter whose cut-on or cut-off wavelength varies along one of said directions.

3. A method as claimed in claim 2 in which the filter means comprise an additional filter which together with the first mentioned filter acts as a band pass filter.

4. A method as claimed in claim 1 in which the filter means comprise a band pass filter and the centre wavelength of the band pass varies along one of said directions.

5. A method as claimed in claim 1 comprising using a lens to focus radiation onto the detector array.

6. A method as claimed in claim 5 in which the lens is a cylindrical lens and the array is at the focal line of the lens.

7. A method as claimed in claim 1 in which a volume of a sample material is positioned between the source and the detector array.

8. A method as claimed in claim 7 in which the volume of sample material is positioned between the source and the filter means.

9. A method as claimed in claim 7 in which the sample material has a tapered shape, whereby the path length of the radiation through the material varies in a direction parallel to the plane of the array.

10. A method as claimed in claim 7 in which one of the characteristics examined is the variation of the intensity of the radiation with respect to path length.

11. A method as claimed in claim 1 in which one of the characteristics examined is the variation of the intensity of the radiation with respect to spatial position.

12. A method as claimed in claim 1 in which one of the characteristics examined is the relationship between the intensity of the radiation and its wavelength.

13. Apparatus for analysing radiation comprising a planar two-dimensional array of radiation detector elements; filter means positioned between the radiation source and the array, the filter means being designed to cause a variation in the intensity of the radiation falling on the array with respect to its wavelength along a first direction parallel to the plane of the array; and means for examining first and second different characteristics of the radiation falling on the array with respect to said first direction and a second direction respectively, the first and second directions being perpendicular to-each other and parallel to the plane of the array.

14. Apparatus as claimed in claim 13 in which the filter means comprise a cut-on or cut-off filter whose cut-on or cut-off wavelength varies along one of said directions.

15. Apparatus as claimed in claim 14 in which the filter means comprise an additional filter which together with the first mentioned filter acts as a band pass filter.

16. Apparatus as claimed in claim 14 in which the intensity varying means comprise a band pass filter and the centre wavelength of the band pass varies along one of said directions.

17. Apparatus as claimed in claim 13 comprising a lens arranged to focus radiation onto the detector array.

18. Apparatus as claimed in claim 17 in which the lens is a cylindrical lens and the array is at the focal line of the lens.

19. Apparatus as claimed in claim 13 including means for holding a volume of a sample material between the source and the detector array.

20. Apparatus as claimed in claim 19 in which the volume of sample material is positioned between the source and the filter means.

21. Apparatus as claimed in claim 20 which the means for holding the sample material has a tapered shape, whereby the path length of the radiation through the material varies in a direction parallel to the plane of the array.

22. Apparatus as claimed in claim 19, including means for examining the variation of the intensity of the radiation with respect to path length.

23. Apparatus as claimed in claim 13 including means for examining the variation of the intensity of the radiation with respect to spatial position.

24. Apparatus as claimed in claim 13 including means for examining the relationship between the intensity of the radiation and its wavelength.
